(19) United States
(12) Patent Application Publication
(10) Pub. No.: US 2014/0185577 A1
(43) Pub. Date: Jul. 3, 2014

(54) METHOD AND APPARATUS FOR ALLOCATING RESOURCES FOR UPLINK CONTROL INFORMATION USING EXTENSION CONTROL INFORMATION

(71) Applicants: Dong Hyun Park, Seoul (KR); Sungjun Yoon, Seoul (KR)

(72) Inventors: Dong Hyun Park, Seoul (KR); Sungjun Yoon, Seoul (KR)

(73) Assignee: Pantech Co., Ltd., Seoul (KR)

(21) Appl. No.: 14/238,284

(22) PCT Filed: Aug. 10, 2012
(86) PCT No.: PCT/KR2012/006416

§ 371 Date: Feb. 11, 2014

(30) Foreign Application Priority Data
Aug. 12, 2011 (KR) 10-2011-0080691

(51) Int. Cl. H04L 5/00

(52) U.S. Cl. CPC H04L 5/0053
USPC 370/329

(57) ABSTRACT

The present disclosure relates to a method and apparatus for allocating resources for uplink control information using extension control information. A method of allocating resources for uplink control information using extension control information, according to an embodiment of the present invention, comprises the following steps: generating extension control information in a data area and transmitting the generated extension control information to a user terminal; and receiving, from the user terminal, uplink control information allocated to a wireless resource area derived from the received extension control information, wherein the wireless resource area derived from the received extension control information does not overlap with a wireless resource area derived from control information in a control area.

### CROSS-REFERENCE TO RELATED APPLICATIONS

This application is the National Stage Entry of International Application PCT/KR2012/006416, filed on Aug. 10, 2012 and claims priority from and the benefit of Korean Patent Application No. 10-2011-0080691, filed on Aug. 12, 2011, all of which are incorporated herein by reference in their entireties for all purposes as if fully set forth herein.

### BACKGROUND

1. Field

The present invention relates to a method and an apparatus for allocating a resource for uplink control information using extension control information in a wireless communication system that uses one or multiple component carriers or one or more antenna ports.

2. Discussion of the Background

As communication systems have developed, various wireless terminals have been utilized by consumers such as companies and individuals.

Current mobile communication systems, for example, 3GPP, LTE (Long Term Evolution), LTE-A (LTE-Advanced), and the like, may be high capacity communication systems capable of transmitting and receiving various types of data such as image data, wireless data, and the like, beyond providing a sound-based service. Accordingly, there is a desire for a technology that transmits high capacity data, which is comparable to a wired communication network. Also, the system is required to include an appropriate error detection scheme that minimizes a loss of information and increases transmission efficiency of the system so as to enhance performance of the system.

Also, because of an increase of an antenna port and an increase of an applicable component carrier, the transmitted downlink control information is increased. Similarly, there needs the scheme that effectively allocates a resource for the uplink control information corresponding to this control information.

### SUMMARY

The present invention relates to a wireless communication system, and an aspect of the present invention is to provide a method and an apparatus for allocating a resource for the uplink control information using the extension control information.

Other aspect of the present invention relates to effectively allocate a resource for the uplink control information in the extension control information.

In accordance with an aspect of the present invention, there is provided a method of allocating a resource of uplink control information using extension control information, the method including: transmitting, to a user equipment, the extension control information generated in a data region; and receiving, from the user equipment, the uplink control information allocated in a radio resource region derived from an index for at least one of an unit region comprising the extension control information, wherein the radio resource region derived from the index for at least one of the unit region comprising the extension control information is not overlapped with a radio resource region derived from an index for at least one of an unit region comprising control information in a PDCCH (Physical Downlink Control Channel) region.

In accordance with another aspect of the present invention, there is provided a method of allocating a resource of uplink control information using extension control information, the method including: receiving, from a base station, the extension control information through a data region; calculating a radio resource region in which the uplink control information is included by using an index for at least one of an unit region comprising the extension control information; and transmitting, to the base station, the uplink control information in the calculated radio resource region, wherein the radio resource region derived from the index for at least one of the unit region comprising the extension control information is not overlapped with a radio resource region derived from an index for at least one of an unit region comprising control information in a PDCCH (Physical Downlink Control Channel) region.

In accordance with another aspect of the present invention, there is provided a base station including: an extension control information generating unit configured to generate extension control information which is to be transmitted in a data region; a transceiving unit configured to transmit the generated extension control information in the data region and receive, from the user equipment, the uplink control information allocated in a radio resource region derived from an index for at least one of an unit region comprising the extension control information; and a controller configured to control the extension control information generating unit and the transceiving unit, and make the transceiving unit to transmit the extension control information so that the radio resource region derived from the index for at least one of the unit region comprising the extension control information is not overlapped with a radio resource region derived from an index for at least one of an unit region comprising control information in a PDCCH (Physical Downlink Control Channel) region.

In accordance with another aspect of the present invention, there is provided a user equipment including: a transceiving unit configured to receive, from a base station, the extension control information through a data region; an extension control information extracting unit configured to extract the received extension control information; and a controller configured to control the extension control information extracting unit and the transceiving unit in order to calculate a radio resource region in which the uplink control information is to be included by using an index for at least one of an unit region comprising the extension control information and transmit, to the base station, the uplink control information in the calculated radio resource region, wherein the radio resource region derived from the index for at least one of the unit region comprising the extension control information is not overlapped with a radio resource region derived from an index for at least one of an unit region comprising control information in a PDCCH (Physical Downlink Control Channel) region.

### BRIEF DESCRIPTION OF THE DRAWINGS

FIG. 1 illustrates a wireless communication system according to embodiments of the present disclosure;

FIG. 2 illustrates a method of allocating a PUCCH resource in an FDD environment according to an embodiment of the present disclosure;

FIG. 3 illustrates an E-PDCCH implementing scheme which is applicable to an embodiment of the present disclosure;

FIG. 4 is a diagram illustrating an example to avoid the collision of resources when an embodiment of the present disclosure is applied in an one-layer E-PDCCH scheme which is applicable to an embodiment of the present disclosure;

FIG. 5 illustrates the E-PDCCH implementing scheme which is applicable to an embodiment of the present disclosure;

FIG. 6 is a diagram illustrating an example to avoid the collision of the resource allocation in two-layer E-PDCCH implementing schemes at which the E-PDCCH according to an embodiment of the present disclosure is included in a PDSCH region and a compact-PDCCH is included in a legacy PDCCH region;

FIG. 7 is a diagram illustrating the PUCCH resource allocation when the E-PDCCH according to an embodiment of the present disclosure is one-layer configured and based on a CCE (interleaving);

FIG. 8 a diagram illustrating the PUCCH resource allocation when the E-PDCCH according to the other embodiment of the present disclosure is one-layer configuration and based on a RB (Non-interleaving);

FIG. 9 is a diagram illustrating the PUCCH resource allocation when the E-PDCCH according to an embodiment of the present disclosure is multi-layer configured and based on a CCE (interleaving);

FIG. 10 is a diagram illustrating the PUCCH resource allocation when the E-PDCCH according to the other embodiment of the present disclosure is multi-layer configured and based on a RB (Non-interleaving);

FIG. 11 is a diagram illustrating the procedure on which a base station according to an embodiment of the present disclosure generates and transmits the E-PDCCH and receives the transmitted uplink control information after the PUCCH resource is allocated to a user equipment through the E-PDCCH;

FIG. 12 is a diagram illustrating the procedure on which the base station according to an embodiment of the present disclosure generates and transmits the E-PDCCH and receives the transmitted uplink control information after the PUCCH resource is allocated to the user equipment through the E-PDCCH;

FIG. 13 is a diagram illustrating the procedure on which the user equipment according to an embodiment of the present disclosure receives the E-PDCCH and transmits the uplink control information after the PUCCH resource is allocated to the user equipment through the E-PDCCH;

FIG. 14 is a diagram illustrating the procedure on which the user equipment according to an embodiment of the present disclosure receives the E-PDCCH and transmits the uplink control information after the PUCCH resource is allocated to the user equipment through the E-PDCCH;

FIG. 15 illustrates a configuration of the base station according to an embodiment of the present disclosure; and

FIG. 16 is a diagram illustrating a configuration of the user equipment according to an embodiment of the present disclosure.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

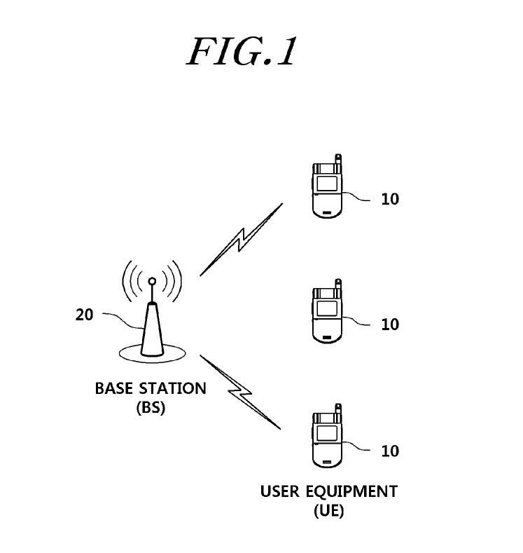

FIG. 1 illustrates a wireless communication system according to embodiments of the present disclosure.

The wireless communication system may be widely installed so as to provide various communication services, such as a voice service, packet data, and the like.

Referring to FIG. 1, the wireless communication system includes a user Equipment (UE) 10 and a Base Station (BS or eNB) 20. Throughout the specifications, the user equipment 10 may be an inclusive concept indicating a user terminal utilized in wireless communication, including a UE (User Equipment) in WCDMA, LTE, HSPA, and the like, and an MS (Mobile Station), a UT (User Terminal), an SS (Subscriber Station), a wireless device, and the like in GSM.

The base station 20 or a cell may refer to a station where communication with the user equipment 10 is performed, and may also be referred to as a Node-B, an eNB (evolved Node-B), a sector, a site, a BTS (Base Transceiver System), an access point, a relay node, and the like.

That is, the base station 20 or the cell may be construed as an inclusive concept including a partial area covered by a BSC (Base Station Controller) in CDMA, a NodeB of WCDMA, an eNB or a sector (site) in LTE, and the like, and may be a concept including various coverage areas such as a mega cell, a macro cell, a micro cell, a pico cell, a femto cell, a communication range of a relay node, and the like.

In the specifications, the user equipment 10 and the base station 20 are used as two inclusive transceiving subjects, which are to embody the technology and technical concepts described in the specifications, and may not be limited to a predetermined term or word. The user equipment 10 and the base station 20 are used as two inclusive Uplink (UL) and Downlink (DL) transceiving subjects, which are used to embody the technology and technical concepts described in the specifications, and may not be limited to a predetermined term or word. In the specifications, the uplink may mean what transmits a data from the user equipment 10 to the base station 20, and the downlink may mean what transmits a data from the base station 20 to the user equipment 10.

The wireless communication system may utilize varied multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like.

Uplink transmission and downlink transmission may be performed based on a TDD (Time Division Duplex) scheme that performs transmission based on different times, or based on an FDD (Frequency Division Duplex) scheme that performs transmission based on different frequencies.

An embodiment of the present invention may be applicable to resource allocation in asynchronous wireless communication that is advanced through GSM, WCDMA, and HSPA, to be LTE and LTE-advanced, and may be applicable to resource allocation in synchronous wireless communication that is advanced through CDMA and CDMA-2000, to be UMB. Embodiments of the present invention may not be limited to a specific wireless communication field, and may be applicable to all technical fields to which a technical idea of the present invention is applicable.

In LTE, a standard may be developed by forming an uplink (UL) and a downlink (DL) based on a single carrier or a pair of carriers. The uplink and the downlink may transmit control information through a control channel, such as a PDCCH (Physical Downlink Control CHannel), a PCFICH (Physical Control Format Indicator CHannel), a PHICH (Physical Hybrid ARQ Indicator CHannel), a PUCCH (Physical Uplink Control CHannel), and the like, and may be configured as a data channel, such as a PDSCH (Physical Downlink Shared CHannel), a PUSCH (Physical Uplink Shared CHannel), and the like, so as to transmit data.

LTE uses a standard based on a single carrier as a base and has discussed coupling of a few bands having a bandwidth of 20 MHz or less, whereas LTE-A has discussed a band of a component carrier having a bandwidth of 20 MHz or more. LTE-A has discussed a multiple-carrier aggregation (hereinafter referred to as a ‘CA’) by taking backward compatibility into consideration based on the base standard of LTE. In an uplink and a downlink, a maximum of 5 carriers are taken into consideration. The number of carriers may be increased or decreased from 5 carriers based on a system environment, and the present invention may not be limited thereto.

There are Uplink ACK/NACK (Acknowledgement/Negative Acknowledgement) transmission and uplink channel information transmission including a CQI (Channel Quality Indicator, hereinafter referred to as a “CQI”), a PMI (Precoding Matrix Indicators referred to as a “PMI”), and an RI (Rank Indicator, referred to as a “RI”) among the various items that are taken into consideration for designing a control channel in the CA.

In LTE-A, backward compatibility of 3GPP LTE Rel-8 is basically taken into consideration to form the CA. Transceiving of CQI/PMI/RI information defined as a standard in LTE Rel-8 is performed by various schemes through an uplink control channel such as a PUCCH (Physical Uplink Control Channel) and a PUSCH (Physical Uplink Shared Channel).

In a case of the CA in LTE-A, a plurality of component carriers exist and an amount of information transmitted through a control channel of an uplink increases based on a number of the carriers and thus, resource allocation performed by forming a resource block group for each carrier may be inefficient. Particularly, in a case of the CA in LTE-A, there may be an asymmetric situation in which a number of uplink carriers is different from a number of downlink carriers. When an amount of information transmitted through a control channel of the uplink increases based on a number of carriers, resource allocation performed by forming a resource block group for each carrier may be more inefficient. Therefore, a scheme of allocating a resource of response control information (ACK/NACK Control information) such as ACK/NACK transmitted through a control channel in an uplink, even in the asymmetric situation, will be described.

The wireless communication system according to an embodiment of the present invention may support an uplink and/or downlink HARQ, and may use a CQI (channel quality indicator) for link adaptation. Also, a multiple access scheme for downlink transmission and a multiple access scheme for uplink transmission may be different from each other. For example, a downlink may use OFDMA (Orthogonal Frequency Division Multiple Access) and an uplink may use SC-FDMA (Single Carrier-Frequency Division Multiple Access).

An embodiment of the present invention may be applied to the CA (carrier aggregation). The CA refers to an environment where a base station and a user equipment transmit and receive a signal using a plurality of component carriers. The plurality of component carriers may be adjacent to one another, or may not be adjacent to one another since a frequency band is spaced apart from one another. Also, a downlink component carrier and an uplink component carrier exist independently and thus, a number of downlink component carriers and a number of uplink component carriers may be the same as or different from one another. The plurality of component carriers may include at least one primary component carrier (PCC) and at least one secondary component carrier (SCC) which is different from the PCC. A main measurement signal or control information may be transceived through a PCC, and an SCC may be allocated through a PCC. The PCC is also referred to as a PCell (Primary Cell), and the SCC is also referred to as a SCell (Secondary Cell).

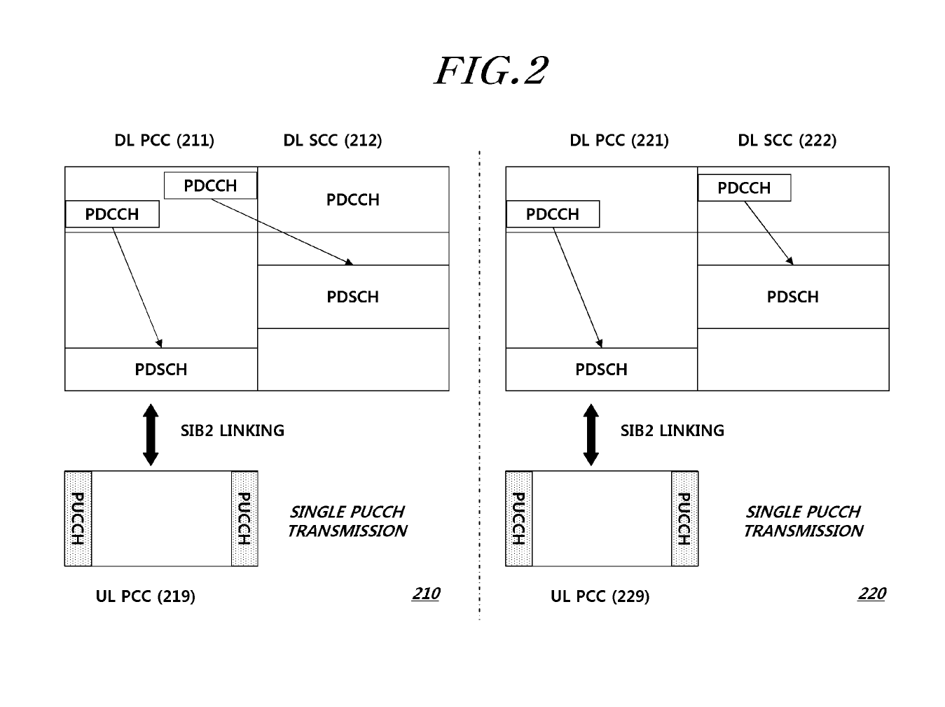

FIG. 2 illustrates a method of allocating a resource of a PUCCH in an FDD environment according to an embodiment of the present disclosure.

FIG. 2 shows a resource allocation scheme for PUCCH format 1b through channel selection in the CA environment of the FDD where there are one or more serving cells.

The diagram 210 in FIG. 2 is an example of cross carrier scheduling performed in the PCC, and the diagram 220 shows that a PDCCH in each component carrier indicates a PDSCH in a corresponding component carrier by applying a general scheduling.

In the diagram 210, PDCCHs transferred through a DL PCC 211 are associated with a PDSCH in the DL PCC 211 and a PDSCH in a DL SCC 212. Conversely, in the diagram 220, each of a PDCCH transferred through a DL PCC 221 and a PDCCH transferred through a DL SCC 222 indicates a PDSCH in a corresponding component carrier.

In this example, PUCCH transmission is performed on only one UL PCC 219 or 229. The UL PCC 219 or 299 is in a SIB2 linking relationship with a DL PCC. Resource allocation schemes for the PUCCH transmission include: i) a scheme of using information on a PDCCH transferred through a DL PCC or information on an added field, ii) a scheme of using a TPC (Transmit Power Control) field and information on a PDCCH downloaded through a DL SCC in a case of SPS(Semi-Persistent Scheduling), and iii) a scheme of deriving a resource through RRC signaling, and the like.

In order to enhance the data transmission throughput, there are many technologies such as Multiple Input/Multiple Output (MIMO), coordinated multi-point transmission/reception (CoMP), relay node and the like but there needs more control information transmitted by the transmitting part such as the base station to apply these technologies.

However, when the size of the control region which the PDCCH is transmitted is limited, the scheme to transmit the control information to be transmitted through the PDCCH within the data region which the PDSCH is transmitted has been considered as the method to enhance the PDCCH transmission throughput. This method may support the larger PDCCH transmission throughput without reducing the PDCCH reception reliability. This control information transmitted through the PDCCH in the data region, for example the PDSCH region, is referred to as extension control information ((Extended-PDCCH, E-PDCCH, X-PDCCH), PDCCH-A (PDCCH-Advanced)), hereinafter referred to as an “E-PDCCH”. The E-PDCCH is applicable to the control channel for Relay such as a R-PDCCH. In order words, the E-PDCCH may include a control channel for relay and a control channel for inter-cell interference coordination. The E-PDCCH may be allocated in the data region (data channel region) of any subframe according to an embodiment of the present invention.

The E-PDCCH described above is new type of the PDCCH considered in the Release-11 (Rel-11) LTE system so that it requires a resource allocation of uplink control information such as the PUCCH. Hereafter, in order to avoid a PDCCH scheduling constraint and solve a problem induced by using the legacy LTE system as it is, a method to enable a more efficient and stable PDCCH and PUCCH resource utilization is described as below.

Currently the resource allocation for the PUCCH transmission in the system such as the relay is configured by higher layer signaling.

First, the resource index n_{PUCCH}^{(1,p)} for each antenna port is configured by higher layer signaling for FDD. Likewise the PUCCH resources n_{PUCCH,l}⁽¹⁾, where 0≦l≦M−1 for HARQ bundling or PUCCH format 1b with channel selection is configured by higher layer signaling for the TDD. M becomes the number of downlink subframe associated with one uplink subframe. M may have the different value according to TDD configuration.

Hereafter, a method to allocate the PUCCH resource according to the E-PDCCH implementing method is described as below.

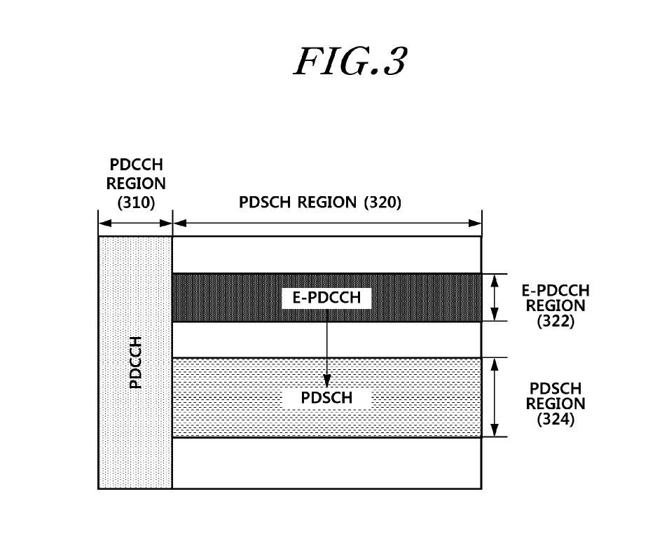

FIG. 3 illustrates an E-PDCCH implementing scheme which is applicable to an embodiment of the present disclosure. FIG. 3 shows one-layer E-PDCCH implementing scheme where the E-PDCCH is included in the PDSCH region.

There may be considered the mode that the legacy PDCCH for the legacy Rel-8/9/10 user equipment is transmitted in a legacy PDCCH region 310 and Rel-11 user equipment performs blind decoding of a E-PDCCH region 322 with higher layer signaling or system information (SI). Similar to the R-PDCCH(Relay PDCCH) used for the legacy relay, the E-PDCCH may make one PDCCH with two kinds of units different from each other. The first is that the E-PDCCH is configured based on the unit of the control channel element (CCE), similar to the legacy PDCCH and the interleaving R-PDCCH, and the second is that the E-PDCCH is configured based on the unit of the resource block (RB), similar to the non-interleaving R-PDCCH. In other words, two types of units (CCE or RB) and four types of aggregation levels make one PDCCH. Therefore one of 1, 2, 4 and 8 CCEs as the first unit according to aggregation level makes one PDCCH and one of 1, 2, 4 and 8 RBs as the second unit according to aggregation level makes one PDCCH.

The R-PDCCH used for the legacy relay has the different unit (CCE or RB) consisting of one PDCCH with respect to either interleaving mode or non-interleaving mode respectively. However, because there don't exist many relays within a single cell in case of the R-PDCCH, the R-PDCCH is configured by occupying the corresponding resource by higher layer signaling such as RRC and continually using the same resource. Because not the relay but the user equipment receives the PDCCH, occupying the corresponding resource may induce a large of both PUCCH resource loss and overhead.

An implicit resource allocation may be used in order to use the legacy PUCCH transmission. The implicit resource allocation may mean what induces the PUCCH resource from specific information or value of the PDCCH.

When the implicit resource allocation is applied based on one layer E-PDCCH in FIG. 3, it cannot avoid the collision with the legacy PDCCH. In other words, the CCE index of the E-PDCCH in one layer E-PCCCH implementing scheme which the E-PDCCH is included within the PDSCH region is equal to the CCE index of the PDCCH within the legacy PDCCH region, which may be the same as the index of the PDCCH derived from the CCE, resulting in the collision of the PUCCH resource allocation.

Therefore, how to efficiently allocate the PUCCH resource between the PDCCH and the E-PDCCH in dependently included in the different regions (PDCCH region 310 and E-PDCCH region 322) from each other is described as below.

The method for allocating the PUCCCH resource in case of the CCE based E-PDCCH (E-PDCCH with interleaving) according to the first embodiment is described as below.

For the legacy FDD, the implicit resource allocation may provide more gain in view of the PUCCH resource overhead than the explicit resource allocation. The formula 1 is related to it.

n_{PUCCH}^{(1),p}=n_{CCE}+N_{PUCCH}⁽¹⁾ [Formula 1]

Where the value of n_{PUCCH}^{(1,p)} indicates the value of the PUCCH resource index to be used on an antenna port p, the value of n_{CCE} indicates the first CCE index with the relevant PDCCH and the value of N_{PUCCH}⁽¹⁾ is provided by higher layer signaling and indicates the total number of resource which the eNB explicitly allocates to the user equipment for transmission of SR, SPS, ARI and ACK/NACK repetition and the like within the relevant cell. Therefore the resource is implicitly allocated to each of the user equipments from the remaining part equal to the total resources for the PUCCH format 1/1a/1b minus the explicitly allocated resources.

The formula 1 above is that the legacy user equipments are to induce the PUCCH transmission resource from the legacy PDCCH transmitted in the PDCCH region. To avoid colliding the legacy user equipments with the user equipment which induces the PUCCH resource from the E-PDCCH region, the formula 2 below is applied so that the user equipment implicitly inducing the PUCCH resource by using the legacy PDCCH prevents the collision of the PUCCH resource from the user equipment implicitly inducing the PUCCH resource by using the new E-PDCCH in advance.

n_{PUCCH}^{(1),p}=n_{CCE}+N_{PUCCH}⁽¹⁾+N_{Offset}⁽¹⁾ [Formula 2]

While the value of n_{PUCCH}^{(1),p} in formula 1 is used when the PUCCH resource is allocated to the legacy user equipment (the resource allocation through the legacy PDCCH), the value of n_{PUCCH}^{(1),p} in formula 2 is used when the PUCCH resource is allocated to the user equipments which perform the resource allocation through the E-PDCCH. Because N_{Offset}⁽¹⁾ is different between formula 1 and 2, the value of n_{PUCCH}^{(1),p} is different between formula 1 and 2 in spite of the same value of n_{CCE}, which makes the PUCCH resource different from each other to be allocated to the user equipments.

The value of N_{Offset}⁽¹⁾ may be derived variously. This value makes the value of n_{PUCCH}^{(1),p} different and the resource allocation efficient in spite of the same value of n_{CCE} between the legacy PDCCH and the E-PDCCH. Of course this value is derived by the separated formula. The embodiment to derive the value of N_{Offset}⁽¹⁾ is shown in formula 3 below.

$$[ Formula 3 ]$$

$$\begin{matrix} {N}_{Offset}^{( 1 )} = ⌊ ( {N}_{RB}^{DL} \cdot ( {N}_{SC}^{RB} \cdot {l}_{DataStart} - 4 \cdot r ) ) / 36 ⌋ \\ \{ \begin{matrix}r = 2 & if {l}_{DataStart} \geq 2 and the number of CRS antenna port is 4 \\ r = 1 & Otherwise\end{matrix} \\ for \\ {N}_{RB}^{DL} > 10 \\ or \\ ( {N}_{RB}^{DL} \leq 10 and normal CP ) , \\ \{ \begin{matrix}r = 3 & if {l}_{DataStart} = 4 and the number of CRS antenna port is 4 \\ r = 2 & if {l}_{DataStart} = 4 and the number of CRS antenna port is 1 or 2 \\ & or if {l}_{DataStart} < 4 and the number of CRS antenna port is 4 \\ r = 1 & Otherwise\end{matrix} \\ for \\ {N}_{RB}^{DL} \leq 10 and extended CP\end{matrix}$$

For formula 3, the value of N_{Offset}⁽¹⁾ the number of CCE in the PDCCH region used in the relevant serving cell. In other words, this value may mean the total number of CCEs of the PDCCHs (radio resource region) in the legacy PDCCH region. Because the CCE index is used when the PUCCH resource derived from the PDCCHs in the legacy PDCCH region is allocated, to add the number which is equal to or greater than the total number of CCE index can make the collision of PUCCH resources derived from the extension control information (E-PDCCH) to be avoided. The value of l_{DataStart} is the value indicating the number of OFDM symbols to be used for the control channel of the relevant serving cell, for example Control Format Indicator (CFI). This value is calculated by decoding the PCFICH when the relevant serving cell is PCell and is received from eNodeB through RRC signaling when the relevant serving cell is SCell. Therefore the user equipments, for example the Rel-11 and more user equipment, can avoid the collision of PUCCH resource allocation with the legacy user equipments using the value of N_{Offset}⁽¹⁾.

Of course it is suggested that the E-PDCCH numbering of n_{CCE} is independent of the legacy PDCCH numbering of CCE.

The detailed embodiment to apply formula 2 and 3 will be described as below.

First, the embodiment to apply formula 2 and 3 for the FDD (frame structure 1) is described as below. When there is one serving cell and the transmission of one antenna port configured, the user equipment induces the PUCCH resource through Formula 3 n_{PUCCH}^{(1),p=p}^{₀}=n_{CCE}+N_{PUCCH}⁽¹⁾+N_{Offset}⁽¹⁾ on the antenna port p=p₀.

When there is the transmission of two antenna ports configured, the user equipment induces the PUCCH resource through n_{PUCCH}^{(1),p=p}^{₀}=n_{CCE}+N_{PUCCH}⁽¹⁾+N_{Offset}⁽¹⁾ on the first antenna port p=p₀ and through n_{PUCCH}^{(1),p=p}^{₁}=n_{CCE}+N_{PUCCH}⁽¹⁾+N_{Offset}⁽¹⁾+1 on the second antenna port p=p₁.

Next, the embodiment to apply formula 2 and 3 for the FDD (frame structure 2) is described as below. The table 1 shows the transmission timing of response control information (ACK/NACK) for the TDD. The table 1 is composed of each of configuration (UL-DL configuration) together with the subframe n (0˜9) and the ACK/NACK transmission for the PDSCH transmitted in the downlink subframe indicated by K according to a K set corresponding to n.

For example, when subframe n=2 and TDD configuration is 2 and the K set becomes 8, 7, 4, 6. The value of M which is the number of downlink subframes related to a specific uplink subframe is equal to 4. In this case the ACK/NACK transmission for the PDSCH transmitted in one or more downlink subframes is performed in the specific uplink subframe. The K set {k₀, k₁, . . . k_{M-1}} is defined by the same index as below.

TABLE 1

| UL-DL | | | | | | | | | | |
|---|---|---|---|---|---|---|---|---|---|---|
| Config- | Subframe n | | | | | | | | | |
| uration | 0 | 1 | 2 | 3 | 4 | 5 | 6 | 7 | 8 | 9 |
| 0 | — | — | 6 | — | 4 | — | — | 6 | — | 4 |
| 1 | — | | 7, 6 | 4 | — | | — | 7, 6 | 4 | — |
| 2 | — | — | 8, 7, 4, 6 | — | — | — | — | 8, 7, | — | — |
| | | | | | | | | 4, 6 | | |
| 3 | — | — | 7, 6, 11 | 6, 5 | 5, | — | — | — | — | — |
| | | | | | 4 | | | | | |
| 4 | — | — | 12, 8, 7, | 6, 5, | — | — | — | — | — | — |
| | | | 11 | 4, 7 | | | | | | |
| 5 | — | — | 13, 12, 9, | — | — | — | — | — | — | — |
| | | | 8, 7, 5, 4, | | | | | | | |
| | | | 11, 6 | | | | | | | |
| 6 | — | — | 7 | 7 | 5 | — | — | 7 | 7 | — |

The table 1 shows downlink association set index K: {k₀, k₁, . . . k_{M-1}} for the TDD.

In case of i) HARQ-ACK bundling, which can have all M values or ii) TDD HARQ-ACK multiplexing for one serving cell configured and subframe n with M=1 for TDD configuration, the user equipment may perform the PUCCH transmission in the subframe n (uplink subframe) by using the PUCCH resource n_{PUCCH}^{(1,p)}.

If the PDCCH which indicates PDSCH transmission or downlink SPS release is transmitted in the subframe n−k, the user equipment may select the value of c satisfied with N_{c}≦n_{CCE}<N_{c+1} from {0,1,2,3}. The value of k may mean the k from the table 1. Because of M=1 in the case ii) above, there is only one of the value of k₀, which means M=1. By the way, in case of ACK/NACK bundling which the value of M is greater than 1, for example the UL-DL configuration 2 of the table 1, one of uplink subframe may be associated with the maximum four of downlink subframes and the value of k of the table 1 may be four such as k₀, k₁, k₂, k₃ The PUCCH resource allocation on the first antenna port p=p₀ is calculated by using formula 4 as below.

n_{PUCCH}^{(1,p=p}^{₀}⁾=(M−m−1)·N_{c}+m·N_{c+1}+n_{CCE}+N_{PUCCH}⁽¹⁾+N_{Offset}⁽¹⁾ [Formula 4]

Nc may be N_{c}=max{0,└[N_{RB}^{DL}·(N_{SC}^{RB}·c−4)]/36┘}, n_{CCE} may means the first CCE index associated with the subframe n−kₘ and kₘ may mean the lowest value in the set K which is applied in case of both the ACK/NACK bundling and the ACK/NACK multiplexing with M=1. What is the lowest value may mean the downlink subframe located temporally most near the uplink subframe.

The PUCCH resource allocation on the second antenna port p=p₁ is calculated by using formula 5 as below.

n_{PUCCH}^{(1,p=p}^{₁}⁾=(M−m−1)·N_{c}+m·N_{c+1}+n_{CCE}+N_{PUCCH}⁽¹⁾+N_{Offset}⁽¹⁾+1 [Formula 5]

Where the value of c may be selected from {0,1,2,3}, which satisfies N_{c}≦n_{CCE}+1<N_{c+1}.

In case of i) TDD HARQ-ACK multiplexing for one serving cell configured ii) subframe n with M>1 (M associated with one uplink subframe n is the number of downlink subframes) for TDD configuration (frame structure 2), the user equipment may perform the PUCCH transmission in the subframe n (uplink subframe) by using the PUCCH resource n_{PUCCH,i}⁽¹⁾. Here, the resource index n_{PUCCH,i}⁽¹⁾ is associated with downlink subframe n−kᵢ.

If the PDCCH which indicates PDSCH transmission or downlink SPS release is transmitted in the subframe n−kᵢ, the PUCCH resource allocation is given by the following formula 6 as described in the formula 4.

n_{PUCCH}⁽¹⁾=(M−m−1)·N_{c}+m·N_{c+1}+n_{CCE,i}+N_{PUCCH}⁽¹⁾+N_{Offset}⁽¹⁾+1 [Formula 6]

In formula 6, the value of c may be selected from {0,1,2,3}, which satisfies N_{c}≦n_{CCE,i}<N_{c+1}. Nc may be N_{c}=max {0,└[N_{RB}^{DL}·(N_{SC}^{RB}·c−4)]/36┘} and n_{CCE,i} is the first CCE index of the PDCCH transmitted in the subframe n−kᵢ.

There may be considered the E-PDCCH without interleaving according to the second embodiment. One E-PDCCH is not CCE base in the first embodiment but RB base configured. The second embodiment is configured different from the first embodiment, which is given by formula 7.

n_{PUCCH}^{(1),p}=n_{VRB}^{E-PDCCH}+N_{PUCCH}⁽¹⁾+N_{Offset}⁽¹⁾+1 [Formula 7]

In the formula above, the new introduced parameter is n_{VRB}^{E-PDCCH} and N_{Offset}⁽¹⁾. N_{Offset}⁽¹⁾ is reused as the value defined in formula 3 and the newly additional n_{VRB}^{E-PDCCH} is defined as below. The value of n_{VRB}^{E-PDCCH} is the index indicating one of VRB with the value of 0˜N_{VRB}^{E-PDCCH}−1. The value of N_{VRB}^{E-PDCCH} may mean the total of frequency bandwidth where the E-PDCCH is potentially transmitted.

Therefore when the RB based E-PDCCH without interleaving is configured by the formula above, the value of n_{VRB}^{E-PDCCH} may prevent the collision of PUCCH resource derived from the legacy PDCCH region.

In detail, when there is one serving cell configured, the formula above is applied as below.

When is one serving cell configured, the formula 7 is applied as below.

If the PDCCH which indicates PDSCH transmission or downlink SPS release is transmitted in the subframe n−4 in a frame structure type 1 (FDD) system, the user equipment may induce the PUCCH resource through n_{PUCCH}^{(1),p=p}^{₀}=n_{VRB}^{E-PDCCH}+N_{PUCCH}⁽¹⁾+N_{Offset}⁽¹⁾ for an antenna port p=p₀ by applying formula 7 when there is one antenna port configured.

The user equipment may induce the PUCCH resource through n_{PUCCH}^{(1),p=p}^{₁}=n_{VRB}^{E-PDCCH}+N_{PUCCH}⁽¹⁾+N_{Offset}⁽¹⁾+1 for the second antenna port p=p₁ by adding “1” to formula 7 when there are two antenna ports configured.

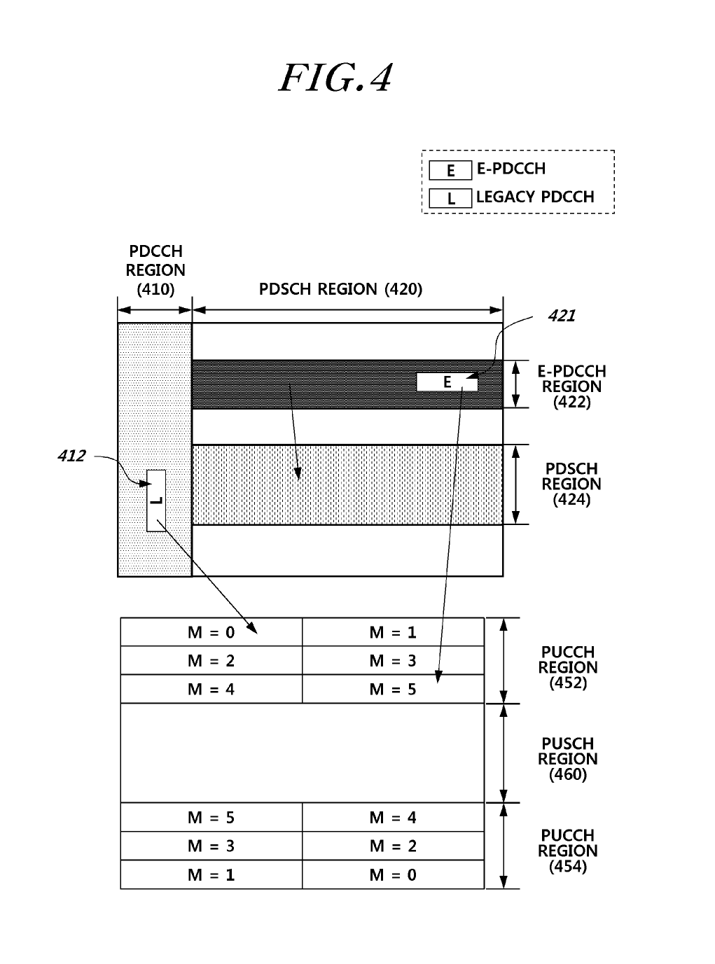

FIG. 4 is a diagram illustrating an example to avoid the collision of resources when an embodiment of the present disclosure is applied in an one-layer E-PDCCH scheme which is applicable to an embodiment of the present disclosure.

An implicit resource allocation may be used in order to use the legacy PUCCH transmission. The implicit resource allocation may mean what induces the PUCCH resource from specific information or value of the PDCCH.

In case of applying the first embodiment based on CCE and the second embodiment based on RB, these may apply separate offsets N_{Offset}⁽¹⁾, n_{VRB}^{E-PDCCH} together with a parameter of the implicit resource allocation in order to use the PUCCH transmission with the legacy PDCCH, resulting in preventing the collision of the PUCCH resource allocation between the legacy PDCCH and the E-PDCCH with either the same CCE or the same RB values. For example, as shown in FIG. 4, even when the index of the legacy PDCCH 412 in the PDCCH region 410 is equal to the index of the E-PDCCH 421 in the E-PDCCH region 422, the PUCCH resource calculated by N_{Offset}⁽¹⁾ is not equal to each other. The result may prevent the collision of the PUCCH resource allocation between the legacy PDCCH and the E-PDCCH.

In other words, although the CCE index or the RB index of the E-PDCCH in an one-layer E-PDCCH scheme which includes the E-PDCCH in the PDSCH region may be equal to the CCE index of the PDCCH in the legacy PDCCH region, their parameters to be used for the implicit PUCCH resources allocation are different from each other, resulting in the different PUCCH resources from each other calculated by the CCE index or the RB index and the like. Accordingly the result may prevent the collision of the PUCCH resource allocation.

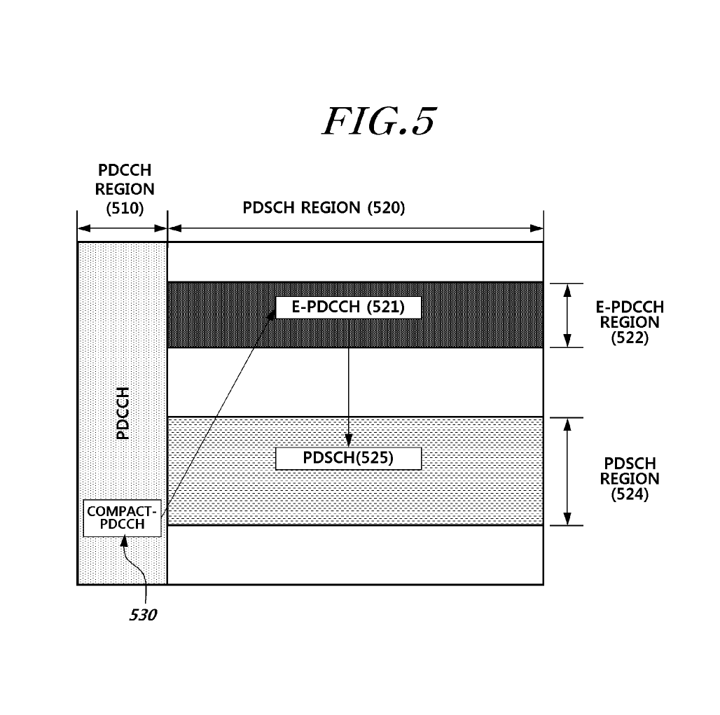

FIG. 5 illustrates an E-PDCCH implementing scheme which is applicable to an embodiment of the present disclosure. In FIG. 5, there is the two-layer E-PDCCH implementing scheme at which the E-PDCCH is included in a PDSCH region and a compact-PDCCH is included in a legacy PDCCH region.

In other words, the compact PDCCH 530 is transmitted in the legacy PDCCH region 510 and the PDSCH is transmitted through the E-PDCCH indicated by that. In case of FIG. 5, the user equipment receives two PDCCH such as the compact PDCCH and the E-PDCCH in view of the user equipment, which means what provides the user equipment with two chances to induce the PUCCH resource.

The third embodiment to allocate the PUCCH resource in the CCE based E-PDCCH with interleaving will be described as below.

When there is more than one serving cell, there needs to derive two resources in a serving cell configured for MIMO transmission mode. Or, when one serving cell is configured within the environment with the TxD (SORTD) transmission configured, there needs to derive two resource in the one serving cell. Typically, the value of n_{PUCCH}^{(1),p=0}=n_{CCE}+N_{PUCCH}⁽¹⁾ is used for the first antenna and the value of n_{PUCCH}^{(1),p=1}=n_{CCE}+N_{PUCCH}⁽¹⁾+1 is used for the second antenna in the environment with one serving cell configured. This is a way to take the PDCCH scheduling restriction and induce the PUCCH resource. As described above, it is shown that there may be the same environment for the PDCCH transmitted in the serving cell with the MIMO mode configured in CA environment.

The user equipment configured to receive the E-PDCCH may receive both the compact PDCCH transmitted in the legacy PDCCH and the E-PDCCH and then do the corresponding PDCCH in the same manner as above. Accordingly two or more resources may be derived in the same manner as below.

i) In case of TXD (one serving cell configured): the PUCCH resource allocation scheme for multiple antenna transmission may use the CCE index of the compact PDCCH and the CCE index of the E-PDCCH, but additionally add the N_{Offset}⁽¹⁾ for the E-PDCCH as shown in Formula.

For first antenna port: n_{PUCCH}^{(1),p=0}=n_{CCE}+N_{PUCCH}⁽¹⁾ from compact PDCCH

For second antenna port: n_{PUCCH}^{(1),p=1}=n_{CCE}+N_{PUCCH}⁽¹⁾+N_{Offset}⁽¹⁾ from E-PDCCH (in case of CCE based) [Formula 8]

The resource is derived from the CCE index of the compact PDCCH in case of P=0 and The resource is derived from the CCE index or the VRB index of the E-PDCCH in case of P=1, which is used for TxD. This can prevent the PDCCH scheduling restriction and more efficiently allocate the PDCCH resource.

ii) The case of MIMO_{—}1 (more than one serving cell configured) may use ACK/NACK Resource Indicator (ARI) for the secondary component carrier as shown in Formula 9.

For first Codeword (CW) of PCell: n_{PUCCH,i=0}⁽¹⁾=n_{CCE}+N_{PUCCH}⁽¹⁾ from compact PDCCH

For second codeword (CW) of PCell: n_{PUCCH,i=1}⁽¹⁾=n_{CCE}+N_{PUCCH}⁽¹⁾+N_{Offset}⁽¹⁾ from E-PDCCH (In case of CCE based)

For SCell: using ARI on PDCCH in SCell [Formula 9]

The PDCCH resource of the first codeword is derived from the compact PDCCH and that of the second codeword from the E-PDCCH with the user equipment configured with MIMO transmission mode which allows for reducing the PDCCH scheduling restriction and more efficiently scheduling the PDCCH resource. It is possible for the SCell to reuse the TPC field as the ARI. In other words, the TPC field within the PDCCH to be transmitted on PCell is used for power control and the TPC field within PDCCH to be transmitted on SCell is reused as the ARI.

iii) In case of MIMO 2 (more than one serving cell configured), when the ARI is not used for the SCC, the formula 10 below may be applied. When the formula 10 may require for four of PUCCH resources, both PCell and SCell may represent the case of MIMO transmission mode.

For first Codeword (CW) in PCell: n_{PUCCH,i=0}⁽¹⁾=n_{CCE}+N_{PUCCH}⁽¹⁾ from compact PDCCH

For second Codeword (CW) in PCell: n_{PUCCH,i=1}⁽¹⁾=n_{CCE}+N_{PUCCH}⁽¹⁾+1 from compact PDCCH

For first Codeword (CW) in SCell: n_{PUCCH,i=2}⁽¹⁾=n_{CCE}+N_{PUCCH}⁽¹⁾+N_{Offset}⁽¹⁾ from E-PDCCH (In case of CCE based)

For second Codeword (CW) in SCell: n_{PUCCH,i=3}⁽¹⁾=n_{CCE}+N_{PUCCH}⁽¹⁾+N_{Offset}⁽¹⁾ from E-PDCCH (In case of CCE based) [Formula 10]

Although the method above may typically take the PDCCH scheduling restriction as it is, it is possible not to use the ARI bit within the DCI format, implying that there is advantageously chance to further use it for other purpose (i.e., original PUCCH TPC command). This method allows for using not further explicit resource but implicit resource, enabling efficient PUCCH resource operation.

The fourth embodiment may take the E-PDCCH without interleaving into consideration. That may compose of the E-PDCCH based on RB, but CCE as described in the third embodiment above.

i) In case of TxD (one serving cell configured): the PUCCH resource allocation scheme for multiple antenna transmission may apply formula 11.

For first antenna port: n_{PUCCH}^{(1),p=0}=n_{CCE}+N_{PUCCH}⁽¹⁾ from compact PDCCH

For second antenna port: n_{PUCCH}^{(1),p=1}=n_{VRB}^{E-PDCCH}+N_{PUCCH}⁽¹⁾+N_{Offset}⁽¹⁾ from E-PDCCH [Formula 11]

ii) In case of MIMO_{—}1 (more than one serving cell configured), it allows for ACK/NACK Resource Indicator (ARI) for the secondary component carrier as shown in Formula 12.

For first Codeword (CW) of PCell: n_{PUCCH,i=0}⁽¹⁾=n_{CCE}+N_{PUCCH}⁽¹⁾ from compact PDCCH

For second Codeword (CW) of PCell: n_{PUCCH,i=1}⁽¹⁾=n_{VRB}^{E-PDCCH}+N_{PUCCH}⁽¹⁾+N_{Offset}⁽¹⁾ from E-PDCCH

For SCell: using ARI on PDCCH in SCell [Formula 12]

The E-PDCCH based on RB may also allow for reducing the PDCCH scheduling restriction and more efficiently scheduling the PDCCH resource.

iii) In case of MIMO 2 (more than one serving cell configured), when the ARI is not used for the SCC, the formula 13 below may be applied. When the formula 13 may require for four of PUCCH resources, both PCell and SCell may represent the case of MIMO transmission mode.

E.x) A=4 (i.e., in case of requiring for four of PUCCH resources, both PCell and SCell with MIMO transmission mode)

For first Codeword (CW) in PCell: n_{PUCCH,i=0}⁽¹⁾=n_{CCE}+N_{PUCCH}⁽¹⁾ from compact PDCCH

For second Codeword (CW) in PCell: n_{PUCCH,i=1}⁽¹⁾=n_{CCE}+N_{PUCCH}⁽¹⁾+1 from compact PDCCH

For first Codeword (CW) in SCell: n_{PUCCH,i=2}⁽¹⁾=n_{VRB}^{E-PDCCH}+N_{PUCCH}⁽¹⁾+N_{Offset}⁽¹⁾ from E-PDCCH

For second Codeword (CW) in SCell: n_{PUCCH,i=3}⁽¹⁾=n_{VRB}^{E-PDCCH}+N_{PUCCH}⁽¹⁾+N_{Offset}⁽¹⁾ from E-PDCCH [Formula 13]

Although the method above may typically take the PDCCH scheduling restriction as it is, it is possible not to use the ARI bit within the DCI format, implying that there is advantageously chance to further use it for other purpose (i.e., original PUCCH TPC command). This method allow for using not further explicit resource but implicit resource, enabling efficient PUCCH resource operation.

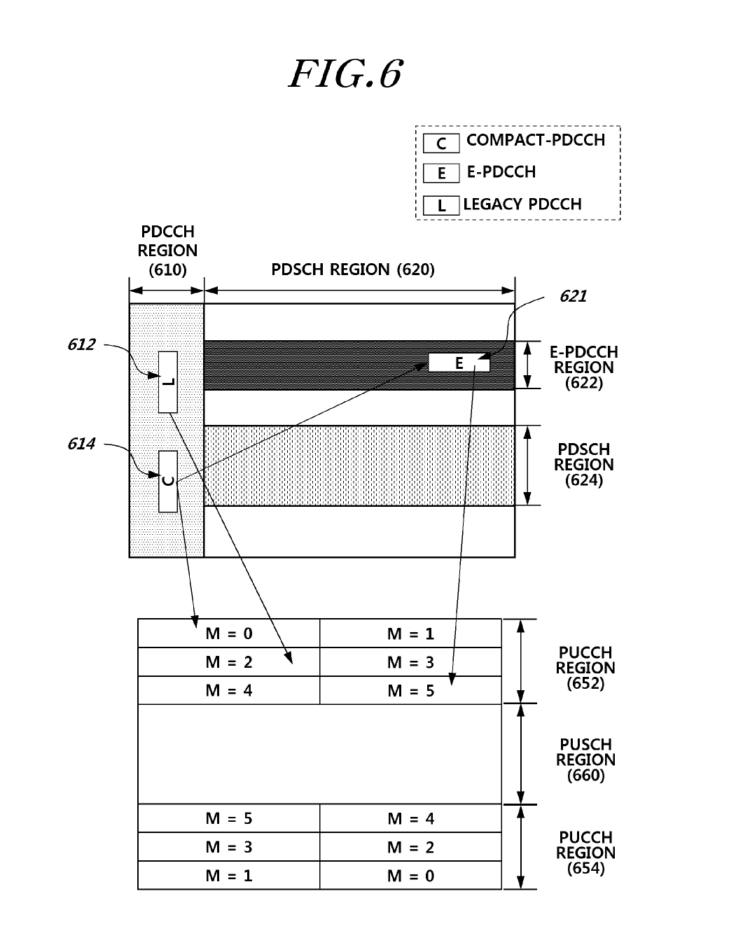

FIG. 6 is a diagram illustrating an example to avoid the collision of the resource allocation in two-layer E-PDCCH implementing schemes at which the E-PDCCH according to an embodiment of the present disclosure is included in a PDSCH region and a compact-PDCCH is included in a legacy PDCCH region.

Applying formula 8, the compact PDCCH 614 and the legacy PDCCH 612 is located within the same PDCCH region 610 in FIG. 6 and then indicates the respective resource on the implicit PUCCH resource allocation so that the collision of the resource cannot occur. Meanwhile it allows the E-PDCCH 614 to allocate the PUCCH resource without colliding between the legacy PDCCH 612 and the compact-PDCCH 614 through N_{Offset}⁽¹⁾ so that the collision of the resource cannot occur

In order to allocate the PUCCH resource under various E-PDCCH implementing scheme as described above, it can be summarized as below.

First, one-layer E-PDCCH may allocate the PUCCH resource by using either n_{CCE} or n_{VRB}^{E-PDCCH} and N_{Offset}⁽¹⁾ under the E-PDCCH implementing scheme, in order to make the implicit resource allocation of the legacy PDCCH to be different. During this procedure, the additional factor may be calculated by considering network bandwidth and access environment such as FDD/TDD configuration, the increase of the number of the antenna and the like. Of course although this parameter may be given by the higher layer signaling, it may be implemented that it is calculated by using the previously received information with the user equipment in order to reduce the number of signaling.

On the other hand, because there may be the compact PDCCH for the multi-layer E-PDCCH, either n_{CCE} or n_{VRB}^{E-PDCCH} may be used in order to differentiate between the compact PDCCH and the legacy PDCCH and N_{Offset}⁽¹⁾ is used in order to differentiate between the E-PDCCH and the legacy PDCCH.

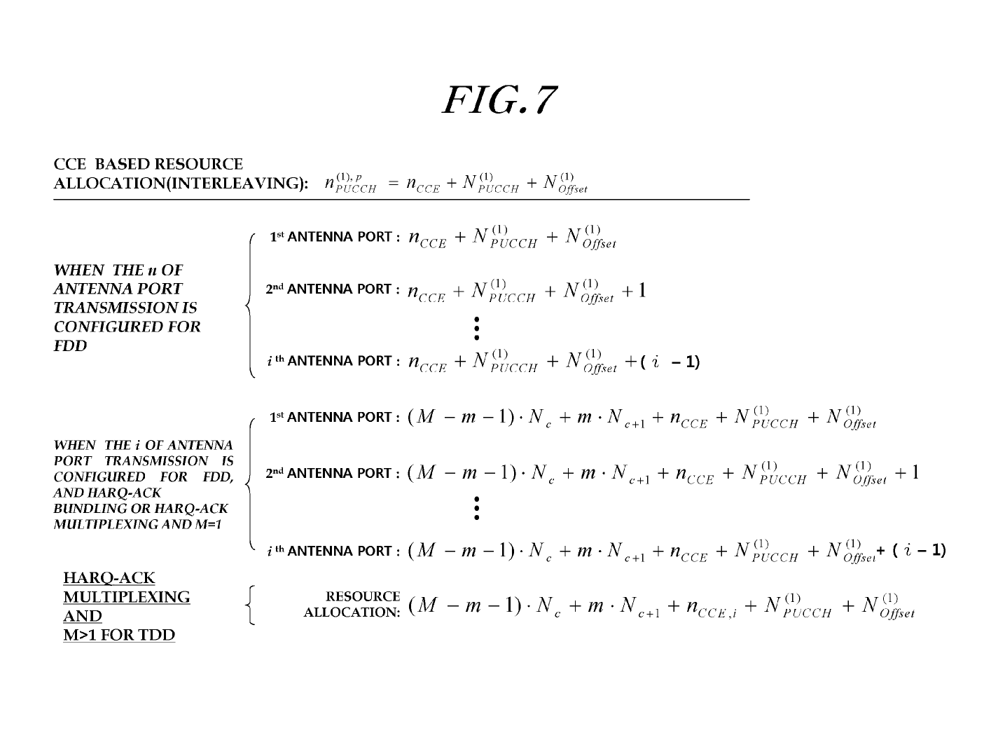

FIG. 7 is a diagram illustrating the PUCCH resource allocation when the E-PDCCH according to an embodiment of the present disclosure is one-layer configured and based on a CCE (interleaving).

As described above, if n_{CCE} and N_{PUCCH}⁽¹⁾ is used, it may possible to calculate the PUCCH resource index n_{PUCCH}^{(1),p} in accordance with network configuration such as TDD/FDD and the like, and the configuration of antenna port.

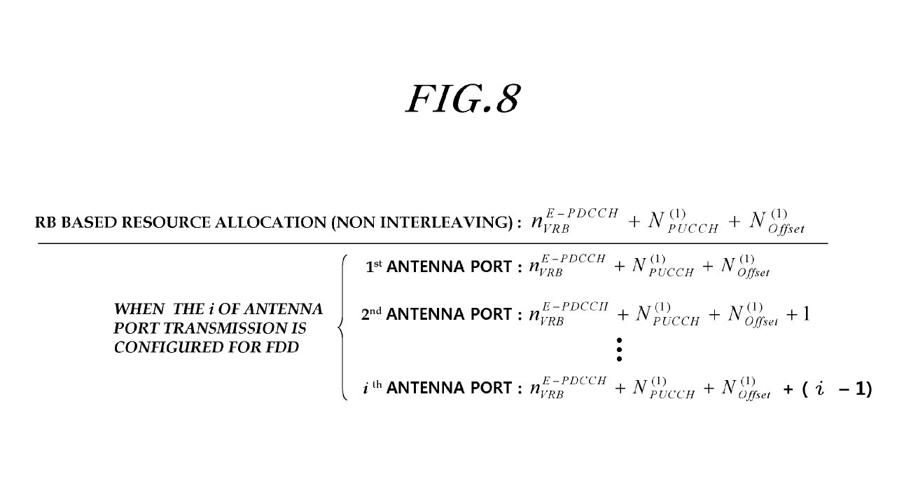

FIG. 8 a diagram illustrating the PUCCH resource allocation when the E-PDCCH according to the other embodiment of the present disclosure is one-layer configured and based on a RB (Non-interleaving). As described above, if n_{VRB}^{E-PDCCH} and N_{Offset}⁽¹⁾ is used, it may possible to calculate the PUCCH resource index n_{PUCCH}^{(1),p} in accordance with the increase or the decrease of the number of the antenna port. The N_{VRB}^{E-PDCCH} value may present the total of frequency bandwidth on which the E-PDCCH may be potentially transmitted, resulting in avoid the collision of the resource allocation with the legacy PDCCH.

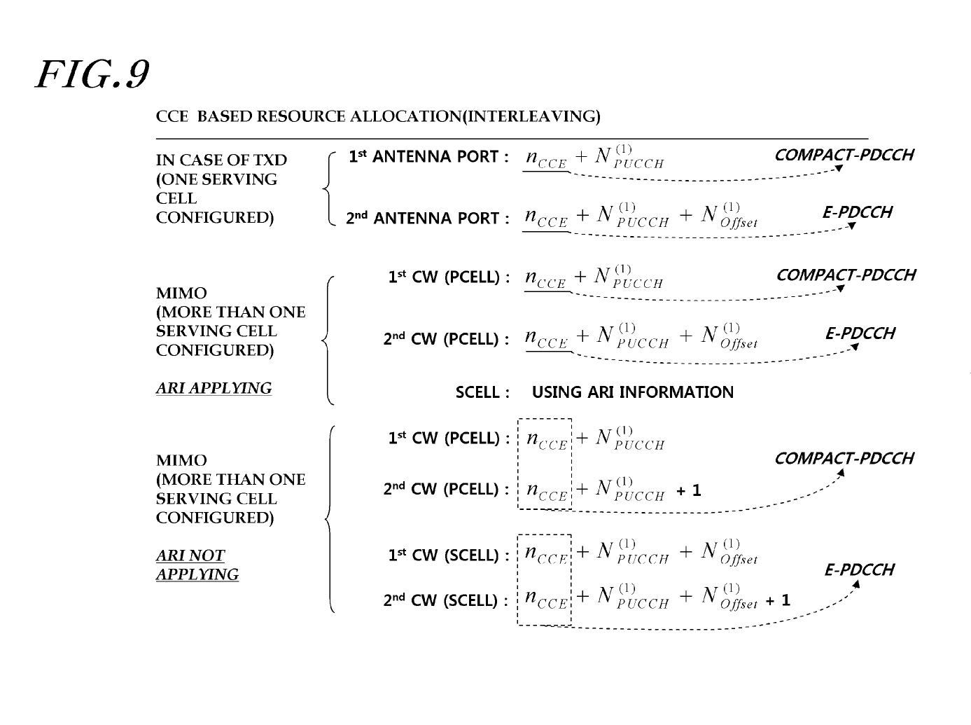

FIG. 9 is a diagram illustrating the PUCCH resource allocation when the E-PDCCH according to an embodiment of the present disclosure is multi-layer configured and based on a CCE (interleaving). It is possible for the E-PDCCH of the multi-layer configuration to implicitly allocate the resource by using the compact PDCCH. When the E-PDCCH is based on a CCE, n_{CCE} calculated from the compact PDCCH, and n_{CCE} and N_{PUCCH}⁽¹⁾ calculated from the E-PDCCH may be used and then the resource may be incremented by “1” or the scheme to use the ARI is used according to the increase of the antenna, the increase of the codeword or the change of network environment such two more serving cells.

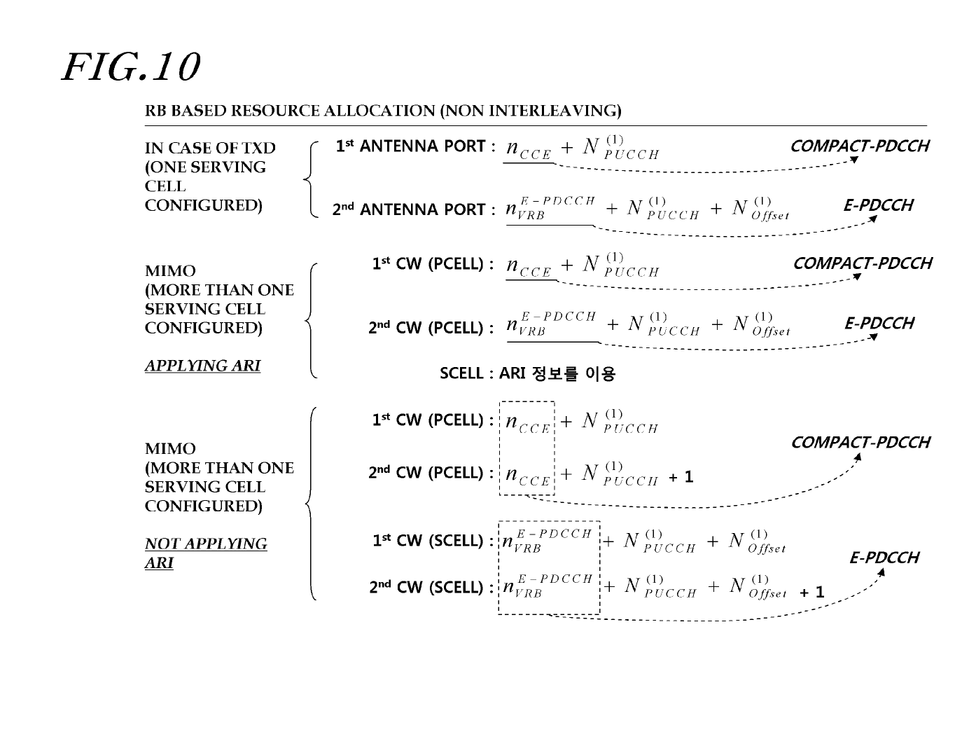

FIG. 10 is a diagram illustrating the PUCCH resource allocation when the E-PDCCH according to the other embodiment of the present disclosure is multi-layer configuration and based on a RB (Non-interleaving). As described above, n_{CCE} from the compact PDCCH, and n_{VRB}^{E-PDCCH} and N_{Offset}⁽¹⁾ from the E-PDCCH may be used and then the resource may be incremented by “1” or the scheme to use the ARI is used according to the antenna increase, the codeword increase or the change of network environment such as two more serving cells.

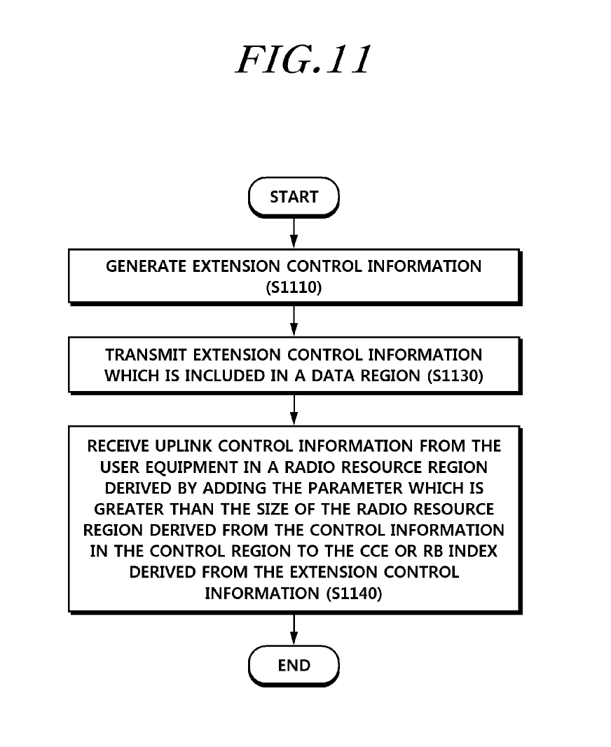

FIG. 11 is a diagram illustrating the procedure on which a base station according to an embodiment of the present disclosure generates and transmits the E-PDCCH and receives the transmitted uplink control information after the PUCCH resource is allocated to a user equipment through the E-PDCCH.

The base station generates an extension control information at S1110. The extension control information may mean the E-PDCCH as described above and the like, which is characterized by being transmitted on the PDSCH (Physical Downlink Shared CHannel) of the data region. When the extension control information is implemented by one-layer implemented scheme, the base station transmits the extension control information which is included in the data region at S1130 and receives the uplink control information from the user equipment in a radio resource region derived by adding the parameter which is greater than the size of the radio resource region derived from the control information in the control region to the CCE or RB index derived from the extension control information at S1140.

The one-layer implemented scheme is described referring to FIGS. 3 and 4.

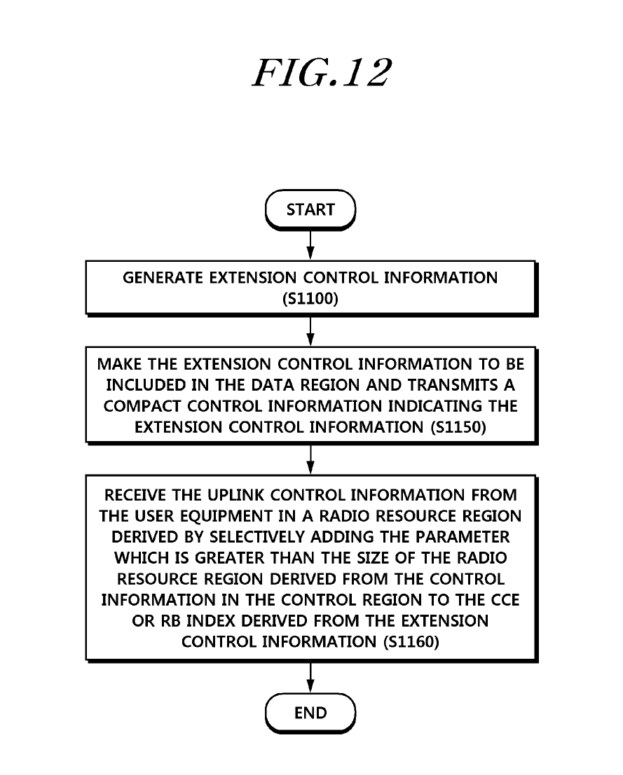

FIG. 12 is a diagram illustrating the procedure on which the base station according to an embodiment of the present disclosure generates and transmits the E-PDCCH and receives the transmitted uplink control information after the PUCCH resource is allocated to the user equipment through the E-PDCCH.

The base station generates the extension control information at S1110. The extension control information may mean the above described E-PDCCH and the like, which is characterized by being transmitted on the PDSCH (Physical Downlink Shared CHannel) of the data region.

On the other hand, when the extension control information is implemented by multiple-layer implemented scheme, the base station makes the extension control information to be included in the data region and transmits the compact control information indicating the extension control information at S1150. The base station receives the uplink control information from the user equipment in a radio resource region derived by selectively adding the parameter which is greater than the size of the radio resource region derived from the control information in the control region to the CCE or RB index derived from the extension control information at S1160.

When the implemented scheme described in FIGS. 11 and 12 is implemented, the radio resource region derived from the extension control information is not overlapped with the radio resource region derived from the control information of the control region.

In other words, the radio resource region derived from the index for the unit region comprising the extension control information is not overlapped with the radio resource region derived from the unit region of the control information.

The various embodiments of resource allocation according to one of the one-layer/multiple-layer scheme, the CCE scheme (interleaving) and the RB scheme (non-interleaving) is described in the formula above and FIG. 7 to 10.

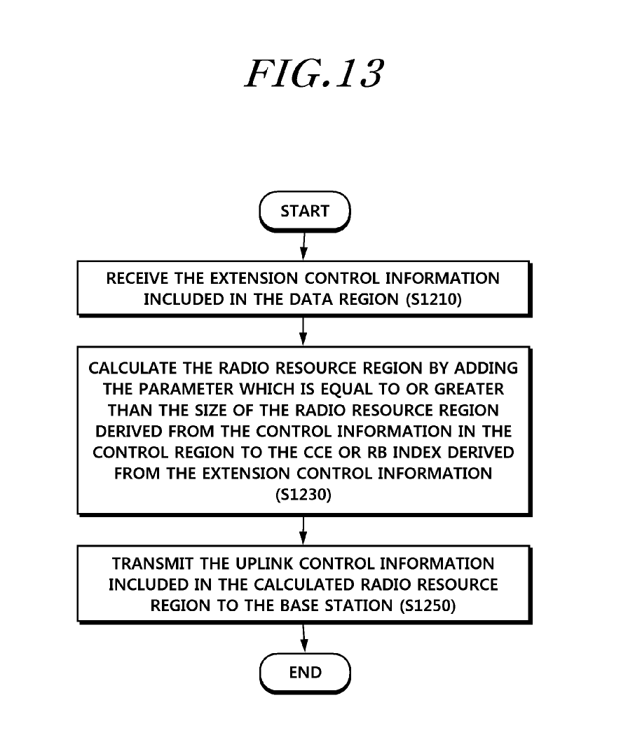

FIG. 13 is a diagram illustrating the procedure on which the user equipment according to an embodiment of the present disclosure receives the E-PDCCH and transmits the uplink control information after the PUCCH resource is allocated to the user equipment through the E-PDCCH.

The user equipment receives, from a base station, the extension control information included in the data region at S1210. When the extension control information is implemented by one-layer implemented scheme as shown in FIGS. 3 and 4, the user equipment calculates the radio resource region by adding the parameter which is equal to or greater than the size of the radio resource region derived from the control information in the control region to the CCE or RB index derived from the extension control information at S1230.

The user equipment transmits, to the base station, the uplink control information included in the calculated radio resource region at S1250.

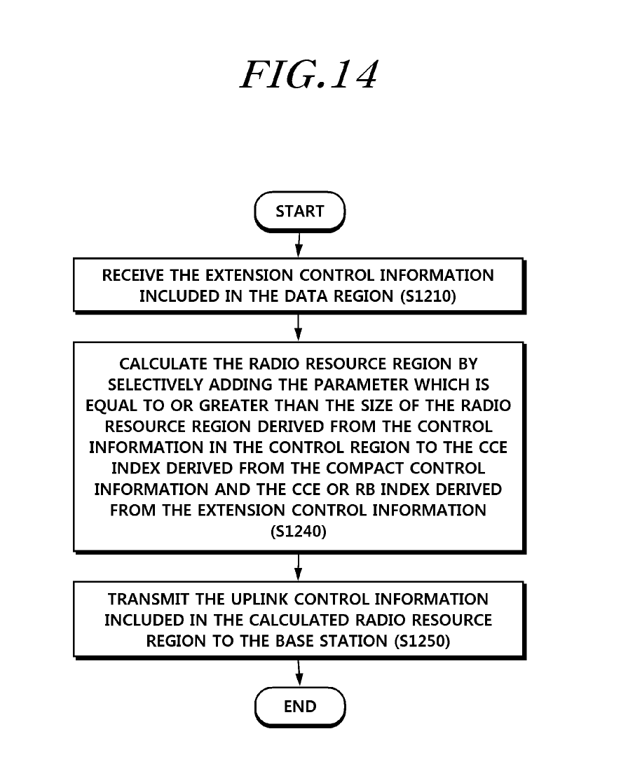

FIG. 14 is a diagram illustrating the procedure on which the user equipment according to an embodiment of the present disclosure receives the E-PDCCH and transmits uplink control information after the PUCCH resource is allocated to the user equipment through the E-PDCCH.

The user equipment receives, from a base station, the extension control information included in the data region at S1210. When the extension control information is implemented by multiple-layer implemented scheme as shown in FIGS. 5 and 6, the user equipment calculates the radio resource region by selectively adding the parameter which is equal to or greater than the size of the radio resource region derived from the control information in the control region to the CCE index derived from the compact control information and the CCE or RB index derived from the extension control information at S1240.

The user equipment transmits the uplink control information included in the calculated radio resource region to the base station at 1250.

When the implemented scheme described in FIGS. 13 and 14 is implemented, the radio resource region derived from the extension control information is not overlapped with the radio resource region derived from the control information of the control region.

The various embodiments of resource allocation according to one of the one-layer/multiple-layer scheme, the CCE scheme (interleaving) and the RB scheme (non-interleaving) is described in the formula above and FIG. 7 to 10.

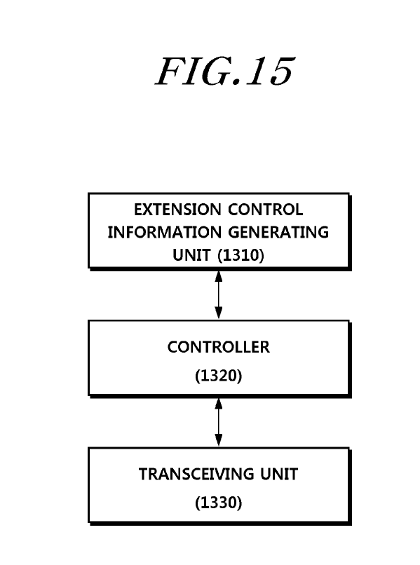

FIG. 15 illustrates a configuration of the base station according to an embodiment of the present disclosure. The base station in FIG. 15 generates the E-PDCCH and transmits it. After the PUCCH resource is allocated to the user equipment through the E-PDCCH, the user equipment performs the PUCCH transmission.

The base station may include the extension control information generating unit 1310, a controller 1320 and a transceiving unit 1330 as all configurations.

The extension control information generating unit 1310 is configured to generate extension control information which is to be transmitted in a data region. The transceiving unit 1330 is configured to transmit the generated extension control information in the data region and receive, from the user equipment, the uplink control information allocated in a radio resource region derived from an index for at least one of an unit region comprising the extension control information.

The controller 1320 is configured to control the extension control information generating unit 1310 and the transceiving unit 1330, and make the transceiving unit 1310 to transmit the extension control information so that the radio resource region derived from the index for at least one of the unit region comprising the extension control information is not overlapped with a radio resource region derived from an index for at least one of an unit region comprising control information in a PDCCH (Physical Downlink Control Channel) region.

As described in FIG. 11 above, when the extension control information is implemented by one-layer implemented scheme, the extension control information is allocated in the radio resource region derived by adding the parameter which is equal to or greater than the size of the radio resource region derived from the control information in the control region to the CCE or RB index derived from the extension control information. The controller 1320 informs the uplink control information in the radio resource region.

As described in FIG. 12, when the extension control information is implemented by multiple-layer implemented scheme, the compact control information indicating the extension control information is included in the control region and the extension control information is allocated in the radio resource region derived by selectively adding the parameter which is equal to or greater than the size of the radio resource region derived from the control information in the control region to the CCE index derived from the compact control information and the CCE or RB index derived from the extension control information. The controller 1320 informs the uplink control information in the radio resource region.

When the implemented scheme described in FIG. 15 is implemented, the radio resource region derived from the extension control information is not overlapped with the radio resource region derived from the control information of the control region.

The various embodiments of resource allocation according to one of the one-layer/multiple-layer scheme, the CCE scheme (interleaving) and the RB scheme (non-interleaving) are described in the formula above and FIG. 7 through FIG. 10.

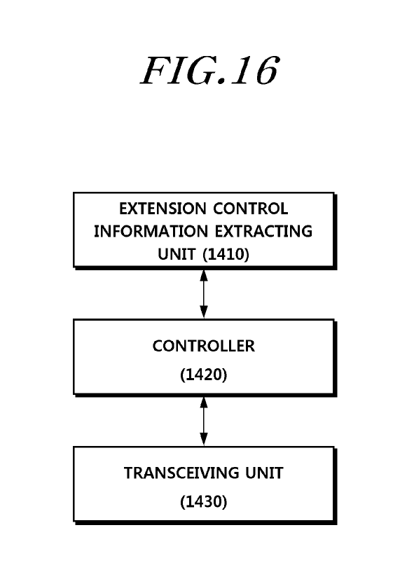

FIG. 16 is a diagram illustrating a configuration of the user equipment according to an embodiment of the present disclosure. The user equipment in FIG. 16 receives the E-PDCCH. After the base station allocates the PUCCH resource to the user equipment through the E-PDCCH, the user equipment performs the PUCCH transmission.

The user equipment includes the extension control information extracting unit 1410, a controller 1420 and a transceiving unit 1430 as all configurations.

The transceiving unit 1430 is configured to receive, from a base station, extension control information through a data region and the extension control information extracting unit 1410 is configured to extract the received extension control information.

The controller 1420 is configured to control the extension control information extracting unit and the transceiving unit in order to calculate a radio resource region in which the uplink control information is to be included by using an index for at least one of an unit region comprising the extension control information and transmit, to the base station, the uplink control information in the calculated radio resource region.

As described in FIG. 13, when the extension control information is implemented by one-layer implemented scheme, the controller 1420 calculates the radio resource region by adding the parameter which is equal to or greater than the size of the radio resource region derived from the control information in the control region to the CCE or RB index derived from the extension control information.

As described in FIG. 14, when the extension control information is implemented by multiple-layer implemented scheme, the compact control information indicating the extension control information is included in the control region and the controller 1420 calculates the radio resource region by selectively adding the parameter which is equal to or greater than the size of the radio resource region derived from the control information in the control region to the CCE index derived from the compact control information and the CCE or RB index derived from the extension control information. The controller 1320 informs the uplink control information in the radio resource region.

When the implemented scheme described in FIG. 16 is implemented, the radio resource region derived from the extension control information is not overlapped with the radio resource region derived from the control information of the control region.

The various embodiments of resource allocation according to one of the one-layer/multiple-layer scheme, the CCE scheme (interleaving) and the RB scheme (non-interleaving) is described in the formula above and FIG. 7 to 10.

The number of the radio resource region as described referring to FIGS. 11 to 16 may means the number of CCEs or the number of REs of the corresponding control region as one example.

The present disclosure may provides a method to induce the resource used for PUCCH transmission when an enhanced PDCCH scheduling method is activated and an apparatus to allocate a resource using therewith and transmit the extension control information included in the allocated resource. Because there cannot be used the previous PUCCH resource allocation scheme in the E-PDCCH as it is, the present disclosure may provide the new PUCCH resource allocation scheme, which enhances all system capability with effective transmission of information.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of allocating a resource of uplink control information using extension control information, the method comprising:
transmitting, to a user equipment, the extension control information generated in a data region; and
receiving, from the user equipment, the uplink control information allocated in a radio resource region derived from an index for at least one of a unit region comprising the extension control information,
wherein the radio resource region derived from the index for at least one of the unit region comprising the extension control information is not overlapped with a radio resource region derived from an index for at least one of a unit region comprising control information in a Physical Downlink Control Channel (PDCCH) region.

2. The method of claim 1, wherein the uplink control information is allocated in the radio resource region which corresponds to a value calculated by adding a parameter which is equal to or greater than the number of Control Channel Elements (CCEs) consisting of the PDCCH region to the index for at least one of the unit region comprising the extension control information.

3. The method of claim 1, wherein the uplink control information is allocated in the radio resource region which corresponds to a value calculated by adding a parameter which is equal to or greater than the number of Control Channel Elements (CCEs) consisting of the PDCCH region to the index for at least one of the unit region comprising the extension control information and further adding a turn number of an antenna port which corresponds to the uplink control information.

4. The method of claim 1, wherein the unit region is either a Control Channel Element (CCE) or a Resource Block (RB).

5. The method of claim 1, wherein the extension control information is configured as a multi-layer scheme;
a compact control information indicating the extension control information is included in the PDCCH region; and
the uplink control information is allocated in the radio resource region which corresponds to a value calculated by adding a parameter which is equal to or greater than the number of Control Channel Elements (CCEs) consisting of the PDCCH region to a CCE index derived from the compact control information and a CCE index or a Resource Block (RB) index derived from the extension control information.

6. A method of allocating a resource of uplink control information using extension control information, the method comprising:
receiving, from a base station, the extension control information through a data region;
calculating a radio resource region in which the uplink control information is to be included by using an index for at least one of a unit region comprising the extension control information; and
transmitting, to the base station, the uplink control information in the calculated radio resource region,
wherein the radio resource region derived from the index for at least one of the unit region comprising the extension control information is not overlapped with a radio resource region derived from an index for at least one of a unit region comprising control information in a Physical Downlink Control Channel (PDCCH) region.

7. The method of claim 6, wherein the calculating of the radio resource region comprises:
calculating the radio resource region in which the uplink control information is to be included by adding a parameter which is equal to or greater than the number of Control Channel Elements (CCEs) consisting of the PDCCH region to the index for at least one of the unit region comprising the extension control information.

8. The method of claim 6, wherein the calculating of the radio resource region comprises:
calculating the radio resource region in which the uplink control information is to be included by adding a parameter which is equal to or greater than the number of Control Channel Elements (CCEs) consisting of the PDCCH region to the index for at least one of the unit region comprising the extension control information and further adding a turn number of an antenna port which corresponds to the uplink control information.

9. The method of claim 6, wherein the unit region is either a Control Channel Element (CCE) or a Resource Block (RB).

10. The method of claim 6, wherein the extension control information is configured as a multi-layer scheme;
a compact control information indicating the extension control information is included in the PDCCH region; and
the calculating of the radio resource region comprises:
calculating the radio resource region in which the uplink control information is to be included by adding a parameter which is equal to or greater than the number of Control Channel Elements (CCEs) consisting of the PDCCH region to a CCE index derived from the compact control information and a CCE index or a Resource Block (RB) index derived from the extension control information.

11. A base station comprising:
an extension control information generating unit configured to generate extension control information which is to be transmitted in a data region;
a transceiving unit configured to transmit the generated extension control information in the data region and receive, from a user equipment, uplink control information allocated in a radio resource region derived from an index for at least one of a unit region comprising the extension control information; and
a controller configured to control the extension control information generating unit and the transceiving unit, and make the transceiving unit to transmit the extension control information so that the radio resource region derived from the index for at least one of the unit region comprising the extension control information is not overlapped with a radio resource region derived from an index for at least one of a unit region comprising control information in a (Physical Downlink Control Channel (PDCCH) region.

12. The base station of claim 11, wherein the uplink control information is allocated in the radio resource region which corresponds to a value calculated by adding a parameter which is equal to or greater than the number of Control Channel Elements (CCEs) consisting of the PDCCH region to the index for at least one of the unit region comprising the extension control information.

13. A user equipment comprising:
a transceiving unit configured to receive, from a base station, extension control information through a data region;
an extension control information extracting unit configured to extract the received extension control information; and
a controller configured to control the extension control information extracting unit and the transceiving unit in order to calculate a radio resource region in which uplink control information is to be included by using an index for at least one of a unit region comprising the extension control information and to transmit, to the base station, the uplink control information in the calculated radio resource region,
wherein the radio resource region derived from the index for at least one of the unit region comprising the extension control information is not overlapped with a radio resource region derived from an index for at least one of a unit region comprising control information in a Physical Downlink Control Channel (PDCCH) region.

14. The user equipment of claim 13, wherein the controller calculates the radio resource region in which the uplink control information is to be included by adding a parameter which is equal to or greater than the number of Control Channel Elements (CCEs) consisting of the PDCCH region to the index for at least one of the unit region comprising the extension control information.
